(19) United States
(12) Patent Application Publication
(10) Pub. No.: US 2004/0257982 A1
(43) Pub. Date: Dec. 23, 2004

(54) Method and communication system for establishing at least one fail safe communication link

(76) Inventors: Norbert Boll, Munchen (DE); Josef Frohler, Baierbrunn (DE); Georg Hein, Munchen (DE); Reiner Kolsch, Isen (DE)

Correspondence Address: Siemens Corporation, Intellectual Property Departement, 170 Wood Avenue South, Iselin, NJ, 08830, US

(21) Appl. No.: 10/489,684

(22) PCT Filed: Sep. 13, 2002
(86) PCT No.: PCT/DE02/03442

(30) Foreign Application Priority Data
Sep. 14, 2001 (DE) 101 45 493.7
Oct. 24, 2001 (DE) 101 52 339.4

(51) Int. Cl. H04L 1/00

(52) U.S. Cl. 370/217; 370/221; 370/225

(57) ABSTRACT

The invention relates to a communication system comprising several connection units, associated to each other and to which several redundant transmission lines, provided for establishing at least one communication link, are respectively connected. In each of said connection units, control functions are provided for controlling functions which are centrally executed in said communication system and/or in the respective communication unit. According to the invention, in case of failure of at least one part of said control functions in one of the connection units, at least the failed communication system-specific and/or connection unit-specific functions are controlled by the control functions of the at least one corresponding connection unit. Advantageously, the line redundancy is combined with a module redundancy for a central connection unit or module, which contains both local interface functions and central control functions of the communication system.

### CROSS REFERENCE TO RELATED APPLICATIONS

This application is the US National Stage of International Application No. PCT/DE02/03442, filed Sep. 13, 2002 and claim the benefit thereof. The International Application claims the benefits of German application No. 10145493.7 filed Sep. 14, 2001, and of German application No. 10152339.4 filed Oct. 24, 2002, all of the applications are incorporated by referent herein in their entirety.

### FIELD OF INVENTION

Method and communication system for establishing at least one failsafe communication link by a communication system located in a communication network.

### BACKGROUND OF INVENTION

In current communication networks or communication systems increased data volumes, higher failsafe requirements and connection of a greater number of subscribers to communication systems demand the implementation of protection switching mechanisms so that, in the event of a hardware or a line failure, the functions within a communication network can be maintained.

DE 198 31 562 for example publishes the principle of line redundancy in communication networks designed in accordance with the Synchronous Digital Hierarchy or in Sonet transmission networks, where line redundancy is used to protect the traffic carried on the lines against failure. This involves using a second line to make a redundant transmission channel available which, in the event of an error, can take over the data traffic of the data line originally used. What is known as 1+1 line redundancy is in widespread use, in which at the sending end of the transmission link the traffic to be transmitted can be sent over what is known as a bridge on both lines almost simultaneously and at the receive end, what is known as a “selector” can be used to select the data traffic from one of the two lines for further processing.

As well as protecting data traffic on the transmission line the functions of the interface module located in the relevant communication system must also be protected against failure Within the framework of module redundancy a second module is made available and assigned to the first module, with the ability to take over the functions of the module originally used in the event to a failure.

Line and module redundancy can be combined as laid down in the publication mentioned above. In this case the protection switching of the data line and the interface module are coupled to each other. Line protection switching automatically leads to module protection switching and vice versa. This method is employed especially in large communication systems which are equipped with a larger number of transmission lines. These communication systems, in addition to the interface modules, are also have modules which look after the central functions of the communication system, such as switching functions or central control functions. These modules can also be protected against failure by module redundancy. The module redundancy of the central modules is not however linked to the module redundancy of the interface modules or to line redundancy.

FIG. 1 shows a block diagram of a communication system in which line and module redundancy are implemented. The line redundancy and the module redundancy of the interface modules are linked to each other. The outgoing data stream from the communication-system is directed by means of a bridge via both interface modules to both outgoing lines whereas a selector is used to select one incoming data stream for further processing from the incoming data streams routed via the interface module. The central control function of this communication system is executed separately from the interface modules and lines but can also have a redundant configuration. When protection switching of the lines and the interface modules is undertaken the central control function is not switched over. Protection the switching of the central control function does not affect the lines and interface modules. The same applies for other central functions implemented in the communications system in each case, such as the call processing function.

In smaller communication systems such as can be found for example in subscriber access networks, for cost reasons on the one hand high levels of integration must be achieved within the communication system and on the other hand redundancy must be provided to protect the ever-greater volumes of data and numbers of subscribers and to improve failsafe performance.

The high level of integration, in addition to increasing the number of subscribers that can be connected to a subscriber line module, also leads to integration of central functions of the communication system with central transmission interfaces used jointly by many subscribers.

In addition a number of these communication systems can be linked to each other in a chain so that on the central communication network side only one transmission line has to be used instead of several. The transmission line used for chaining is also in a redundant configuration in this case—see FIG. 2. For reasons of cost the transmission interface, together with the transmission interface leading to the central network and central functions of the communication system, are integrated onto one module.

Combining central functions and central transmission interfaces on one module or interface module means that the line redundancy of the transmission lines and the module redundancy of the common modules can no longer be coupled as they were previously. Neither may the line redundancies of the transmission line leading to a central communication network and the transmission line used for chaining be coupled to each other. The disadvantage that would result from this is that for line protection switching of the transmission line leading to the central communication network central functions of the communication system, especially the central control functions and also the transmission line used for chaining would also have to be switched over. Equally disadvantageously, with line protection switching in one section of a chain of communication systems, all sections of this chain as well as the central functions of the communications systems combined into this chain would have to be switched over.

### SUMMARY OF INVENTION

The object of the invention is thus to realize a line and module redundancy for a communication system in which the transmission interface of the transmission line and the central control functions are integrated on a module or access unit. The object is achieved, starting with a method and a communications system in accordance of the preambles of Patent claims 1 and 9, by their identifying features.

With the method in accordance with the invention for realizing at least one failsafe communication link through a communication system arranged in a communication network a number of access units are provided, arranged in the communications system and assigned to each other, to which in each case one of a number of redundant transmission lines is connected to realize at least one communication link. Communication link-specific information is transferred to one of the redundant transmission line provided for implementing the at least one transmission link and to the access unit connected to it. Control functions are provided in each of the access units to control communication system specific functions realized centrally in the communication system and/or access unit-specific functions realized in the relevant access unit.

The important aspect of the method in accordance with the invention lies in the fact that on failure of least a part of the control functions in one of the access units, at least the failed communication system-specific and/or access unit-specific functions will be controlled by the control functions of the at least one assigned access unit.

The major advantage of the method in accordance with the invention lies in the fact that in communication networks or communication systems which are located in the subscriber access area for example—also referred to as Digital Subscriber Line Access Multiplexers DSLAM—failsafe transmission interfaces to the central communication network and central functions of the communication system can be integrated onto one of module or access unit at low cost. The central functions can include control functions, call processing functions, timing and synchronization devices, management interfaces etc. or subfunctions of one or more of these functions.

The method in accordance with the invention advantageously combines a line redundancy for one or more transmission lines with module redundancy for a central module or access unit which contains both the interface functions and also the control functions of the communication system. In this case the line redundancy of the interfaces remains independent of each other and protection switching of a transmission line or a transmission interface it does not also lead to protection switching of the module or access unit. The protection switching of the central functions or the module can lead to the protection switching of the transmission lines connected to them. This produces the following advantages

low-cost realization of module and line redundancy sine transmission interfaces and central functions are integrated on one module.

limited effect of faults in a communication network since, despite integration of a transmission interface and the central control functions on one module, a failure of a transmission line does not additionally lead to protection switching of the module or the access unit including the central control function and thereby to additional downtimes.

limited effect of faults in the communication network, since despite the integration of a number of transmission interfaces onto one module a failure of a transmission line does not affect further transmission lines beyond module redundancy.

Further advantageous embodiments of the method in accordance with invention as well as a communication system for implementing at least one failsafe communication link can be taken from the further claims.

### BRIEF DESCRIPTION OF THE DRAWINGS

The method in accordance with the invention is explained below on the basis of a number of diagrams. The diagrams show:

FIG. 1 a schematic diagram of a communication system in which line and module redundancy are implemented,

FIG. 2 the daisy-chaining of a number of communication systems,

FIG. 3 a network-side access of the communication system to one or more further communication systems,

FIG. 4 a communication system in which, in accordance with the invention, the line and module redundancy are implemented independently of one another,

FIGS. 5-7 examples of the protection switching of a transmission line in the event of a line failure and the protection switching of a module in the event of circuit failure as well as their effects on the other redundant functions.

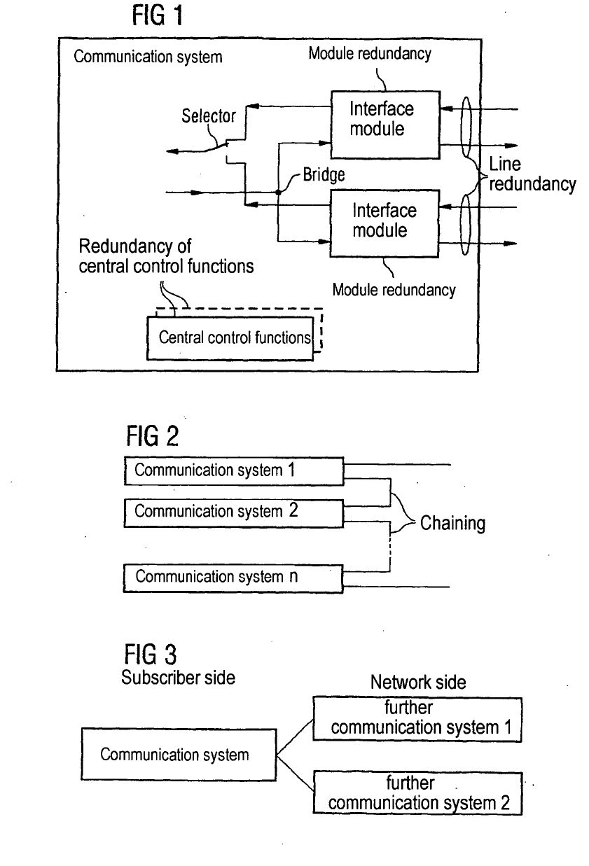

### DETAILED DESCRIPTION OF INVENTION

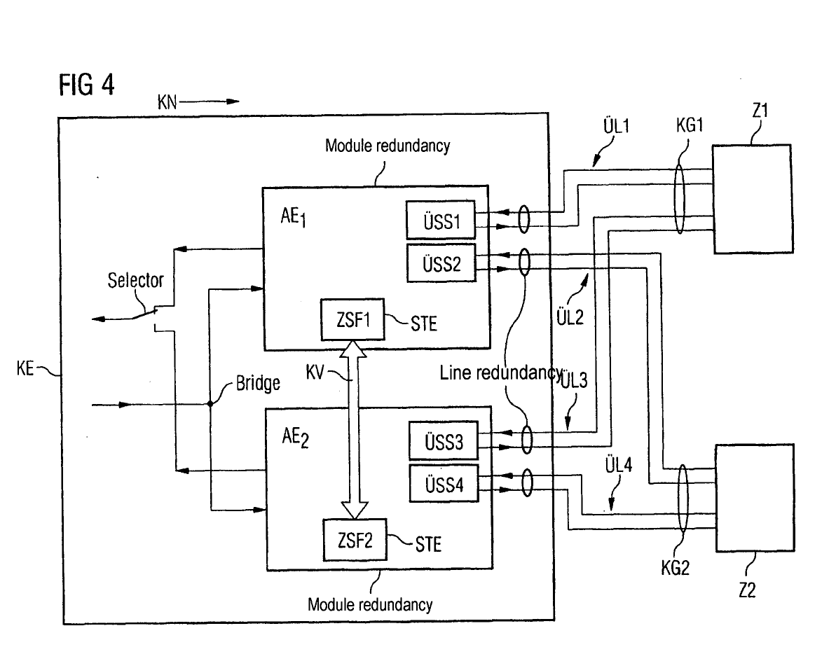

FIG. 4 shows a block diagram of a communications system KE located in a communication network, for example an SDH communication network in which the independence of line and module redundancy is fulfilled in accordance with the invention. The redundant transmission lines ÜL1, ÜL3, or ÜL2, ÜL4 provided within the framework of a failsafe communication link kb1, 2 are connected to redundant transmission interfaces ÜSS1 . . . 4, in which case these redundant transmission interfaces ÜSS1 . . . 4 are located on different central modules or access units AE1, 2. The transmission lines ÜL1, ÜL3 or ÜL2, ÜL4 in this case form of a pair as regards the line redundancy and as regards the communication link kb1,2 to be realized in each case.

For the further exemplary embodiment it is assumed that the first and the third transmission line ÜL1,2 are connected to a first further communication system Z1 and the second and fourth transmission line UL2,4 are connected to a second further communication system Z2—shown in FIG. 4.

Furthermore redundant central control functions zsf1 or zsf2 are realized in the communication system KE, in which case the redundant control functions zsf1, 2 are also located on the different central access units AE1, 2. These central control functions zsf1, zsf2 are performed by a control unit STE or by a processor which can also perform local control functions on the relevant access unit AE1, 2, for example control functions for the transmission interfaces ÜSS1, 2 or ÜSS3, 4. The central control functions zsf1, 2 are connected to each other via a communication connection KV via which the sequence of protection switching can be coordinated and via which the central control functions zsf1, 2 can be synchronized with each other. The communication connection KV contains both hardware dominant parts for time-critical protection switching procedures and for protection switching cases in which a software-controlled switchover is no longer possible, as well as software dominated parts for less time critical sequences.

In the communication system shown in FIG. 4 the existence of a bridge and a selector function which the reader is assumed to be familiar is also indicated without its location or embodiment within the communication system being described in any greater detail.

The subscriber-side interfaces of the communications system, such as for example xDSL interfaces or further transmission interfaces used for cascading are significant components of the communications system which are not shown in FIG. 4.

The redundancy architecture in accordance with the invention shown in FIG. 4 is not dependent on the realization of the central call processing function of the communication system. This redundancy architecture can for example be realized together with a is-based call processing architecture, A switching network based or star-type serial interface-based call processing architecture. The call processing architecture can itself also be a redundant configuration and parts of this call processing architecture can be integrated on the central access units AE1 or AE2.

The connection between the communication system and a TMNS system (TMN: Telecommunication Management Network) can be made using what is known as an inband connection. In this case the connection to the TMN system is routed together with the other traffic as part of an “inband connection” on the transmission lines It can also be realized in accordance with an “outband connection”, in which case the communication system is connected to the TMN system via a separate interface, for example an Ethernet interface. Both options can be realized with the aid of the method in accordance with the invention or with the redundancy architecture according to the invention.

The central clock generator function for a communication system can also be integrated onto the central access units AE1, 2.

Protection switching in the sense of line redundancy can take place on failure of a transmission line ÜL1 . . . 4. Protection switching in the sense of module redundancy can be undertaken for a fault in the hardware or in parts of the hardware of an access unit BG1, 2 or with a non-repairable software error in the central control function zsf1, 2. The redundancy of the central control function zsf1, 2 is thus a component of the module redundancy. A hardware fault on a module or access unit AE1, 2 can also be a fault in the hardware of a transmission interface ÜSS1 . . . 4.

In accordance with the invention it is possible, with a fault that can be uniquely assigned to the central control function, to undertake protection switching of the central control function zsf1, 2 without simultaneous protection switching of the module or access unit AE1, 2. The protection switching of the transmission line ÜL1 . . . 4 as a result of the protection switching of the central control function of an access unit AE1, 2 can advantageously be avoided here. In this case however the error in the central control function zsf1, 2 may not however affect the functions necessary for protection switching of the central control function zsf1, 2. To replace the defective module or access unit AE1, 2 protection switching can however be necessary later for the access unit AE1, 2.

If the software for the central control function of an access unit AE1, 2 is updated, the independence of line and module redundancy can be used to advantage by first updating or loading a first central control function zsf1, 2 with new software while the other unit takes over active control of the communication system KE. After updating of the first central control function zsf1 the central control function can be switched over and the second central control function zsf2 loaded or updated with new software while the first central control function zsf1 takes over the active function of controlling the communication system KE. A switchover of the transmission lines ÜL1, 2 or ÜL3, 4 connected to an access unit AE1, 2 in each case is not required here.

The central control function zsf1, 2 can for example be switched over with a manual switchover command for test purposes. A switchover of the transmission lines ÜL1, 2 or ÜL3, 4 is not necessary here either.

On protection switching of a transmission line (line redundancy) the data traffic transferred over this transmission line is switched over a using the bridge and selector function of the communication system KE to the redundant transmission line ÜL1 . . . 4. The data traffic on the line connected to the second transmission interface and ÜSS1 . . . 4 is not subject to any switchover in this case. This line remains in the same state as it was before the switchover of the first line. The switchover of a transmission line does not lead to the switchover of the central control function zsf1, 2.

On protection switching of the access unit or module AE1, 2 (module redundancy) all functions of the module will be transferred to the redundant module. These functions also include the functions of the transmission interfaces ÜSS1, 2 or ÜSS3, 4. Transmission lines for which the data traffic is to be routed via the module for which protection switching is to be undertaken must also be protection switched as part of the switchover.

In accordance with the invention, the measures to be undertaken as part of line redundancy do not have any affect on the other transmission line connected to the relevant access unit AE1, 2 in each case. Furthermore the measures to be undertaken as part of line redundancy do not have any affect on module redundancy. Measures for module redundancy can however include measures for line redundancy. Further the central control function zsf1, 2 of an access unit AE1, 2 can be switched over independently of line redundancy and module redundancy. Two exemplary embodiments will be used below to illustrate protection switching of a transmission line ÜL1 . . . 4 in the case of a line fault and protection switching of a module or access unit AE1, 2 in the case of a hardware fault on the access unit AE1, 2 as well as their effects on the other redundant functions.

The state in which the traffic selected as active by the selector is to be transmitted over a transmission line ÜL1 . . . 4 is indicated below by the operating state “active”. The redundant line ÜL1 . . . 4 in this case has the operating state “standby”. The active central control function zsf1, 2 is also described by the “active” operating state whereas the redundant control function zsf1, 2 is to be described by the “standby” operating state.

### EXAMPLE 1

### Line Protection Switching

In the initial state, as shown in FIG. 5, transmission lines ÜL1 and ÜL2 as well as central access unit AE1 are in the “active” state.

The transmission lines ÜL1 . . . 4 are for example STM-1 transmission lines in accordance with the Synchronous Digital Hierarchy (SDH), with ÜL1 and ÜL2 representing working transmission lines in the sense of the SDH/Sonet line redundancy and transmission lines ÜL3 and ÜL4 representing “protection lines”. The control protocol of the SDH/Sonet line redundancy is running on the “protection lines” ÜL3, 4.

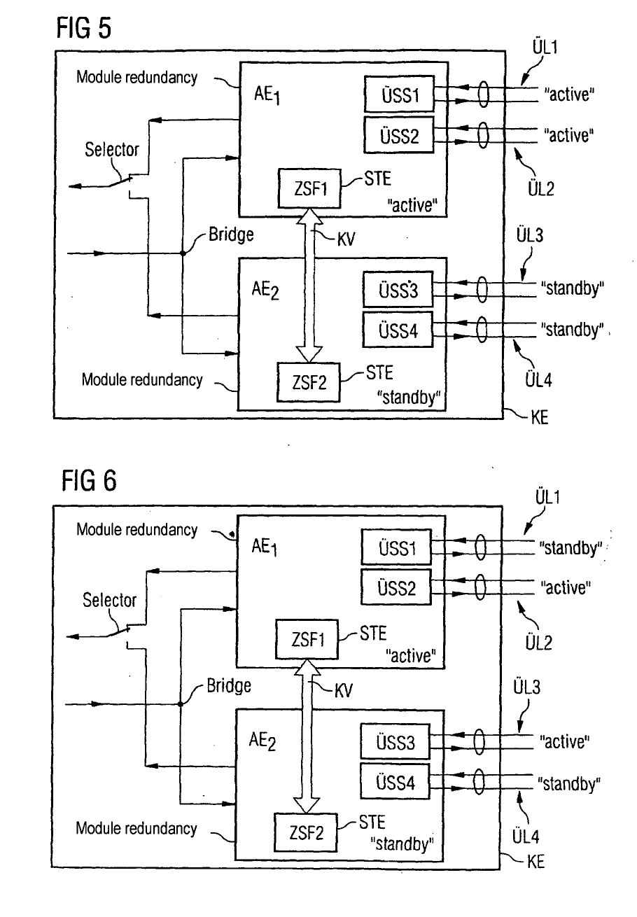

An error on transmission line ÜL1 with the operating state “active” is detected by the transmission interface ÜSS1 arranged on the first access unit AE1. The local control function of the access unit AE1 contained in the central control function zsf1 notifies this error via the communication connection KV to the local control function contained in the central control function zsf2 of the second access unit AE2 Via the third transmission line ÜL3 the protection switching of the transmission lines via the control protocol of the SDH/Sonet line redundancy is agreed and controlled with the device or communication system connected to the other end of the transmission lines ÜL1 and ÜL3. Within the communication system KE data traffic transmitted between the subscriber-side modules—not shown—and the first transmission line ÜL1 is switched over by means of the bridge and selector to the transmission line ÜL3. The data traffic transmitted between the second transmission line ÜL2 and the first transmission line ÜL1 is also switched over by mean of the bridge and selector to a connection between the second and third transmission lines ÜL2 and ÜL3. In accordance with invention protection switching of the modules does not take place After execution of the line protection switching—this state is shown in FIG. 6—the transmission lines ÜL3 and ÜL2 and also the access unit AE1 are in the “active” state. The transmission line ÜL2 and ÜL4, as well as the first access unit AE1 were not protection switched.

### EXAMPLE 2

### Module Protection Switching

In the initial state, as shown in FIG. 6, transmission lines ÜL3 and U\ddot{L}2 as well as the first access unit AE1 are in the “active” state. Furthermore the central control function zsf1 arranged in the first access unit AE1 is in the “active” state. Furthermore the conditions specified in Example 1 also apply to this exemplary embodiment.

The local control function of the first access unit AE1 contained in the central control function zsf1 detects a hardware fault on the first access unit AE1 and notifies this to the central control function zsf1. The central control function zsf1 transfers the corresponding information about the hardware fault via the communication connection KV to the central control function zsf2 arranged in the second access unit AE2. With the aid of the transferred information the central control function zsf2 arranged in the second access unit AE2 is notified that module protection switching must take place, in which case the central control function zsf2 performs protection switching. Depending on the effects of the hardware fault on the central access unit AE1 a controlled line protection switching for the transmission lines ÜL2 and ÜL4 can be undertaken before the module protection switching.

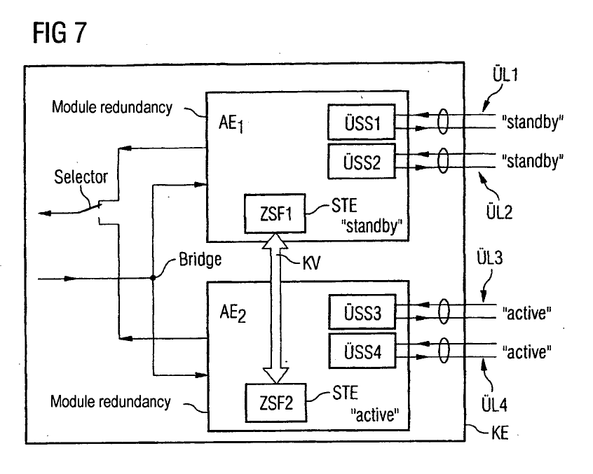

After the module protection switching has been executed—shown in FIG. 7—the transmission lines ÜL3 and ÜL4 as well as the second access unit AE2 are in the “active” state. The transmission lines ÜL2 and ÜL4 must also have been switched over as part of module protection switching while transmission lines ÜL1 and ÜL3 are already in a state in which module protection switching does not lead to line protection switching.

The hardware-dominated components of the communication connection KV between the first and the second access unit AE1, AE2 name in the exemplary embodiment are explained in more detail below. The following functions should be provided via hardware-based interfaces between the access units AE1 and AE2:

Function 1:

Detection of a defect of the partner access unit AE1, AE2, in which case it must be assumed at the defective access unit or module that the central control function zsf2 or parts of the central control function are no longer operable.

Function 2:

The detection of the presence of an active redundancy module or redundancy access unit in the running or the active system. This Is necessary if for example after a repair a partner module or partner access unit of the communication system is inserted during active operation. On the basis of the hardware-based interface the inserted access unit can recognize even before its communication interface is activated to the active partner module or partner access unit whether central system resources or system interfaces may be activated on the inserted access unit.

Function 3:

The deactivation of external interfaces of a defective access unit or module by the redundant partner module or partner access unit. In this case the redundant, active partner module or partner access unit can initiate diagnosis functions before deactivation of the external interfaces of the partner module or partner access unit for pinpointing errors in the system. Through the deactivation of the external interfaces of a defective module or access unit an isolation of the fault state between specific fault sources can be achieved, so that the requirements for an undisturbed or possibly restricted protection switching by the partner module or partner access unit are possible.

1.-14. (canceled)

15. A method for establishing at least one failsafe communication link by a communication system in a communication network, comprising:
providing a plurality of access units in the communication system and assigned to one another;
connecting a plurality of redundant transmission lines to each access unit for establishing the communication link;
transmitting communication-link-specific information over a transmission line and an access unit associated with the transmission line to establish the communication link;
providing control functions in each access unit for controlling communication system-specific functions implemented in the communication system and/or for controlling access unit-specific functions implemented in the associated access units; and
in event of failure of at least a part of the control functions in one of the access units, controlling the failed communication system-specific and/or access unit-specific functions by the control function of the at least one assigned access unit.

16. A method in accordance with claim 15, wherein upon failure of the transmission line transmitting the information within the framework of the communication link, the communication link-specific information is transmitted over a further redundant transmission line and the access unit associated with the transmission line is provided within a framework of the communication link.

17. A method in accordance with claim 15, wherein the communication-link specific information is transferred within a framework of a number of substantially simultaneously established communication links via the access units assigned to each other and the transmission lines connected to them.

18. A method in accordance with claim 17, wherein upon failure of at least a part of the access unit-specific functions in an access unit and/or for faults in the information transfer over a transmission line connected to the associated access unit, only the communication link-specific information already transferred as part of the disturbed communication link via the associated access unit and the transmission lines connected to the associated access unit is transferred via at least a further redundant transmission line and the access units associated to the transmission lines provided within a framework of the communication link.

19. A method in accordance with claim 15, wherein the communication network and the transmission lines comprise a communication network corresponding to a Synchronous or Plesiochronous Digital Hierarchy or an Asynchronous Transfer Mode.

20. A method in accordance with claim 15, wherein in each of the access units supervision functions detect the failure of at least a portion of the control function in an access unit with the aid of a communication connection established between the assigned access units.

21. A method in accordance with claim 20, wherein the presence of at least one further assigned access unit is detectable by the monitoring functions in the access unit.

22. A method in accordance with claim 20, wherein the monitoring functions include further diagnosis functions through which errors or faults in an assigned, failed access unit is analyzed.

23. A communication system for implementing at least one fail-safe communication link over a communication network, comprising:
a plurality of access units arranged in the communication system and connected to each other;
a plurality of redundant transmission lines connected to each access unit respectively for establishing a communication link, the redundant transmission lines and an associated access unit adapted to transfer communication link-specific information for establishing the communication link; and
a control unit provided in each access unit to control communication network-specific functions implemented in the communication system and/or access unit-specific functions implemented in the associated access unit,
wherein the access units and/or the control units are connected to each other via the communication connection so that, upon failure of at least a portion of the communication system-specific and/or access unit-specific functions in an access unit, at least the failed communication system-specific and/or access unit-specific functions are controlled with the the control unit connected via the communication connection.

24. A communication system in accordance with claim 23, wherein the access units and/or the control units are connected to each other via the communication connection so that, upon failure of the transmission line transmitting the information within the framework of the communication link, the communication link-specific information is transmitted over one of the further redundant transmission line and the access unit associated with the transmission line is provided within a framework of the communication link.

25. A communication system in accordance with claim 23, wherein a plurality of transmission lines for establishing a number of substantially simultaneously conducted communication links are connected to the access units.

26. A communication system in accordance with claim 25, wherein the access units and the control units are designed so that upon failure of at least a part of the access unit-specific functions in an access unit and/or with faults during information transfer via a transmission line connected to an access unit, only the communication link-specific information previously transferred within the framework of the disturbed communication link via the access unit and the transmission lines connected to the corresponding access unit is transmitted via a further redundant transmission line and the access unit connected to it provided within the framework of the disturbed communication link.

27. A communication system in accordance with claim 23, wherein a device is provided in each of the access units to implement monitoring functions through which with the aid of the communication connection set up between the assigned access units the failure of the control function in the access unit is detected.

28. A communication system in accordance with claim 23, wherein in the access units and/or control units devices are provided to implement diagnosis functions through which errors or faults in an assigned, failed access unit is analyzed.

29. A method in accordance with claim 16, wherein the communication-link specific information is transferred within a framework of a number of substantially simultaneously realized communication links via the access units assigned to each other and the transmission lines connected to the associated access unit.

30. A method in accordance with claim 16, wherein the communication network and the transmission lines comprise a communication network corresponding to a Synchronous or Plesiochronous Digital Hierarchy or an Asynchronous Transfer Mode.

31. A method in accordance with claim 16, wherein in each of the access units supervision functions detect the failure of at least a portion of the control function in an access unit with the aid of a communication connection established between the assigned access units.

32. A communication system in accordance with claim 24, wherein a plurality of transmission lines for establishing a number of substantially simultaneously conducted communication links are connected to the access units.
